(19) United States
(12) Patent Application Publication
(10) Pub. No.: US 2018/0004430 A1
(43) Pub. Date: Jan. 4, 2018

(54) Chunk Monitoring

(71) Applicant: Hewlett Packard Enterprise Development LP, Houston, TX (US)

(72) Inventors: Alexander M. Merritt, Palo Alto, CA (US); Dejan S. Milojicic, Palo Alto, CA (US)

(21) Appl. No.: 15/545,880

(22) PCT Filed: Jan. 30, 2015
(86) PCT No.: PCT/US2015/013764

§ 371 Date: Jul. 24, 2017

(51) Int. Cl. G06F 3/06; G06F 11/30; G06F 11/34; H04L 29/08

(52) U.S. Cl. CPC G06F 3/0611; G06F 3/067; G06F 11/3409; G06F 11/3034; G06F 3/0604; G06F 3/0644; G06F 3/0631; H04L 67/32

(57) ABSTRACT

One example of a system includes a plurality of clients, a master chunk coordinator, and a plurality of chunk servers. Each client submits requests to access chunks of objects. The master chunk coordinator maintains chunk information for each object. Each chunk server includes a chunk monitor to monitor client requests, maintain chunk statistics for each chunk based on the monitoring, and transmit the chunk statistics for each chunk to the master chunk coordinator. The master chunk coordinator instructs the chunk servers to re-chunk objects, replicate chunks, migrate chunks, and resize chunks based on the chunk statistics to meet specified parameters.

### BACKGROUND

Online services are becoming increasingly data-intensive and interactive. To manage the large amount of data utilized by these services, data management systems have been evolving towards systems having more diverse memory configurations, including systems having massive memory capacities and byte-addressable persistent technologies such as non-volatile memory. Such systems are expected to host increasingly diverse data types, such as social graphs and user-uploaded content, as both interactive applications and applications that perform real-time analysis of such content become more integral to online services.

### BRIEF DESCRIPTION OF THE DRAWINGS

FIG. 1 is a block diagram illustrating one example of a system.

FIG. 2 is a block diagram illustrating one example of an object metadata table.

FIG. 3 is a block diagram illustrating one example of the system components for the monitoring and maintenance of chunk statistics.

FIGS. 4A-4C illustrate one example of chunking.

FIG. 5A illustrates one example of chunk reuse.

FIG. 5B illustrates one example of chunk hotness.

FIG. 5C illustrates one example of chunk read/write ratio.

FIG. 5D illustrates one example of chunk concurrent demand.

FIG. 6 is a flow diagram illustrating one example of a method for operating the system.

FIG. 7 is a flow diagram illustrating one example of a method for adding an object to the system.

FIG. 8 is a flow diagram illustrating one example of a method for client access of an object in the system.

FIG. 9 is a flow diagram illustrating one example of a method for replicating a chunk based on reuse.

FIG. 10 is a flow diagram illustrating one example of a method for accessing chunks based on concurrent demand.

FIG. 11 is a flow diagram illustrating one example of a method for splitting chunks based on the chunk hotness and chunk read/write ratio.

FIG. 12 is a flow diagram illustrating one example of a method for migrating chunks based on relatedness.

FIG. 13 is a block diagram illustrating one example of a processing system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Systems hosting increasingly diverse data types for both interactive applications and applications that perform real-time analysis of such content pose challenges for data management systems. One such challenge includes storing the content in memory and providing quality-of-service guarantees while efficiently adapting to varying changes in use of the system. Some systems may not fully leverage the capabilities of platforms to provide efficient use, may be unable to maintain efficient use with changes to the data being managed, and/or may be unable to observe online system behavior.

Accordingly, examples of this disclosure describe a data management system that actively monitors and adaptively adjusts data placement and relocation techniques to provide improved performance guarantees, increased utilization through efficient use of the network fabric, and the ability to autonomously adapt to changes in use. Examples of the disclosure provide an overall improvement to quality-of-service, adapt to different application characteristics, and provide improved locality through targeted placement of replicas guided by dynamic monitoring of chunk characteristics. In addition, examples of the disclosure provide increased network utilization by enabling parallel requests to multiple replica locations at once, reduced access time volatility by leveraging chunk replication, and the ability to dynamically adapt to changes in workload patterns at a per chunk granularity.

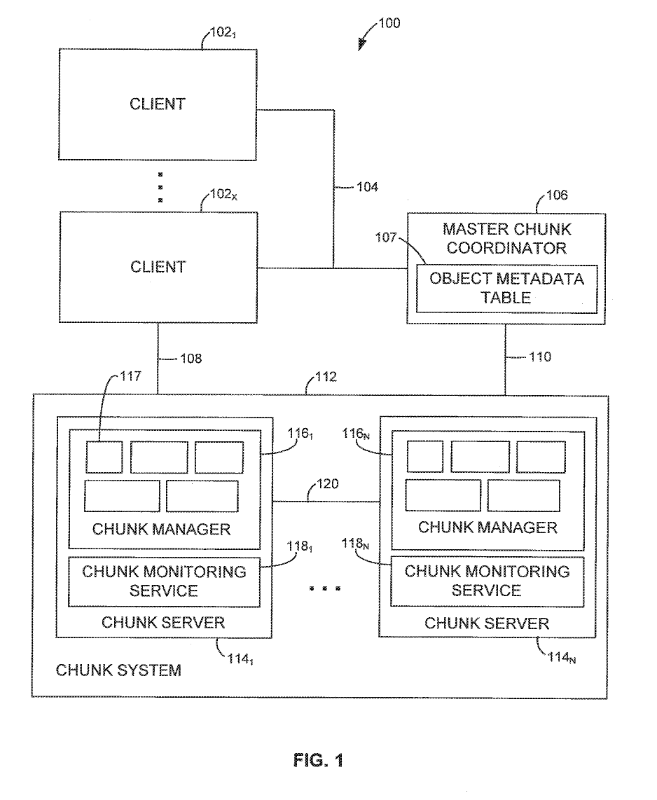

FIG. 1 is a block diagram illustrating one example of a system 100. In one example, system 100 is a distributed active in-memory object store. System 100 includes a plurality of clients 102₁-102ₓ, where “X” is any suitable number of clients, a master chunk coordinator 106, and a chunk system 112. Each client 102₁-102ₓ is communicatively coupled to master chunk coordinator 106 through a communication path 104 and to chunk system 112 through a communication path 108. Master chunk coordinator 106 is communicatively coupled to chunk system 112 through a communication path 110. Master chunk coordinator 106 includes an object metadata table 107.

Chunk system 112 includes a plurality of chunk servers 114₁-114_{N}, where “N” is any suitable number of chunk servers depending on the storage capacity of chunk system 112. Each chunk server 114₁-114_{N} is communicatively coupled to other chunk servers 114₁-114_{N} through a communication path 120. Each chunk server 114₁-114_{N} includes a chunk manager 116₁-116_{N} and a chunk monitoring service 118₁-118_{N}, respectively. In one example, a client may reside on a chunk server 114₁-114_{N} and master chunk coordinator 106 may reside on a chunk server 114₁-114_{N}. Communication paths 104, 108, 110, and 120 may be part of a network, such as an Ethernet network, the Internet, or a combination thereof.

Each client 102₁-102ₓ executes at least one application that stores data in chunk system 112. Each client may submit read, write, delete, and/or append requests for data stored in chunk system 112. Client data is stored in chunk system 112 as objects. As used herein, an “object” is a logical application-level container for storing data in chunk system 112. Each object has a unique key and a size. In chunk system 112, each object includes a set of at least one chunk.

As used herein, a “chunk” is an internal logical system-level container for managing object state. Each chunk is associated with exactly one object and represents a contiguous segment of data of the object. Chunk system 112 by default does not assume a particular structure for application objects and thus manages them as contiguous memory regions. Chunk system 112, however, may be informed by the application about the content of application objects to better guide how chunking is performed (e.g., at which boundaries to chunk). Each chunk is specified by an offset and a length within the object. Chunks may have different lengths and there may be a variable number of chunks for any given object.

Master chunk coordinator 106 responds to client requests (e.g., adding new objects, mutating objects, and removing objects). Master chunk coordinator 106 maintains object metadata table 107 that contains an information table for each object including the object name, the list of chunks that make up the object, the order of the chunks, and the location of each chunk replica. As used herein, a chunk “replica” is an internal system-level structure representing a copy of object state. A chunk may have several replicas, each of which is able to serve requests for the portion of the object specified by the chunk. Chunk replicas may be distributed across chunk system 112 and each chunk may have a variable number of replicas.

In one example, multiple master chunk coordinators may be used with consistent hashing algorithms to look up the master chunk coordinator responsible for maintaining a specific object's metadata, thus preventing a central master chunk coordinator from becoming a hotspot or point of failure. In this example, a centralized observant manager may be used to simplify coordination and/or rebalancing/chunking efforts across the system at large.

Each chunk manager 116₁-116_{N} of each chunk server 114₁-114_{N}, respectively, provides an object service that allows the server's memory to be used to store chunk replicas (e.g., 117) and respond to requests from master chunk coordinator 106 and clients 102₁-102ₓ. Each chunk manager 116₁-116_{N} responds to requests from master chunk coordinator 106 to perform object management operations such as dynamic chunking, replication, and migration. Each chunk manager 116₁-116_{N} responds to requests from clients 102₁-102ₓ to access data.

Each chunk monitoring service 118₁-118_{N} of each chunk server 114₁-114_{N}, respectively, monitors requests from clients 102₁-102ₓ to collect statistics on each chunk. The statistics may include hotness, reuse, read/write ratio, concurrent demand, and relatedness for each chunk. The chunk statistics are periodically transmitted to master chunk coordinator 106 and stored in object metadata table 107. Master chunk coordinator 106 uses the chunk statistics to instruct chunk system 112 to re-chunk objects, replicate chunks, migrate chunks, and resize chunks as needed to maintain compliance with specified parameters, such as quality-of-service parameters provided by a client application. The specified parameters may include error rates, bandwidth, throughput, transmission delay, availability, and/or other suitable parameters. In one example, the specified parameters may vary by object or sets of objects stored in the system.

Each client 102₁-102ₓ includes a key-value object store interface for accessing chunk system 112. A client may request a read, write, append, or remove operation. A read (e.g., get) operation and a write (e.g., put) operation act on objects as a whole. A put operation may add a new object to the system or entirely overwrite an existing object. An append operation does not replace an object. Rather, data is appended to the object using new chunks.

A read request may occur in the presence of only clients submitting read requests, in the presence of a single client submitting an append request, or in the presence of a single client submitting a write request. To read an object in the presence of only clients submitting read requests, the client contacts master chunk coordinator 106 to request the list of chunks for an object. From the set of chunk servers hosting a replica for each chunk, the client chooses one chunk server and sends a request for the data in the replica chunk to be sent to the client. Master chunk coordinator 106 may provide the client with rules for choosing which chunk server to communicate with to maintain compliance with quality-of-service parameters, for load-balancing, and/or to meet an intended performance.

To read an object in the presence of a single client submitting an append request, the client submitting the append request contacts master chunk coordinator 106 to acquire a write lease on the object. The master chunk coordinator replies with the chunk server to which to send data. The client sends the data to the specified chunk server. The chunk server stores the data into a new chunk for the object. The chunk becomes visible to the master chunk coordinator once the chunk server closes the chunk and requests the master chunk coordinator to select the next chunk location for the client to continue writing. A client read request for the object is fulfilled as described above. The master chunk coordinator may notify the client of subsequent chunks as they become available or visibility may not exist until the next read operation is requested.

To read an object in the presence of a single client submitting a write request, the client submitting the write request contacts master chunk coordinator 106, which selects chunk servers to host replicas. The master chunk coordinator determines the number of replicas and chunk sizes to initially use. Chunk servers may pass written data to other chunk servers for creating replicas. The client submitting the write request initiates sending data to the chunk server. The master chunk coordinator assigns a temporary key to this object but the key is not visible to new read operations until the write operation completes. Once the write operation completes, the master chunk coordinator automatically swaps the object key for the temporary key and the old chunks are recycled.

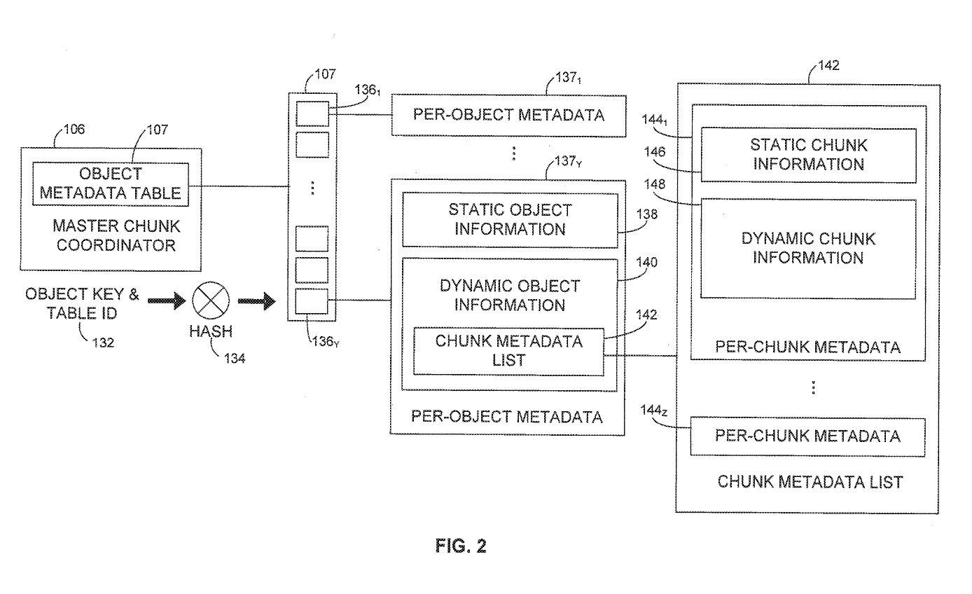

FIG. 2 is a block diagram illustrating one example of object metadata table 107. As illustrated in FIG. 2, object metadata table 107 is stored on master chunk coordinator 106. Object metadata table 107 includes a plurality of objects 136₁-136_{Y}, where “Y” is the number of objects in the table. Each object 136₁-136_{Y} is associated with an object key and table identifier 132, which is used to access each object via a hash 134. Each object 136₁-136_{Y} includes per-object metadata 137₁-137_{Y}, respectively. As indicated for example by per-object metadata 137_{Y}, the per-object metadata includes static object information 138 and dynamic object information 140. Static object information 138 includes the table identifier, object name, and/or any other suitable information about the object that does not change while the object is stored in the system. Dynamic object information 140 includes a chunk metadata list 142 and other information such as object length, type, creation/modification time, and any other suitable information about the object that may change while the object is stored in the system.

Chunk metadata list 142 includes per-chunk metadata 144₁-144_{Z}, where “Z” is the number of chunks for the object. As indicated for example by per-chunk metadata 144₁, the per-chunk metadata includes static chunk information 146 and dynamic chunk information 148. Static chunk information 146 includes the chunk offset, component identifier, length and/or any other suitable information about the chunk that does not change while the chunk is stored in the system. Dynamic chunk information 148 includes a chunk type, hotness statistics, reuse statistics, read/write ratio statistics, concurrency statistics, replica chunk server list, and any other suitable information about the chunk that may change while the chunk is stored in the system.

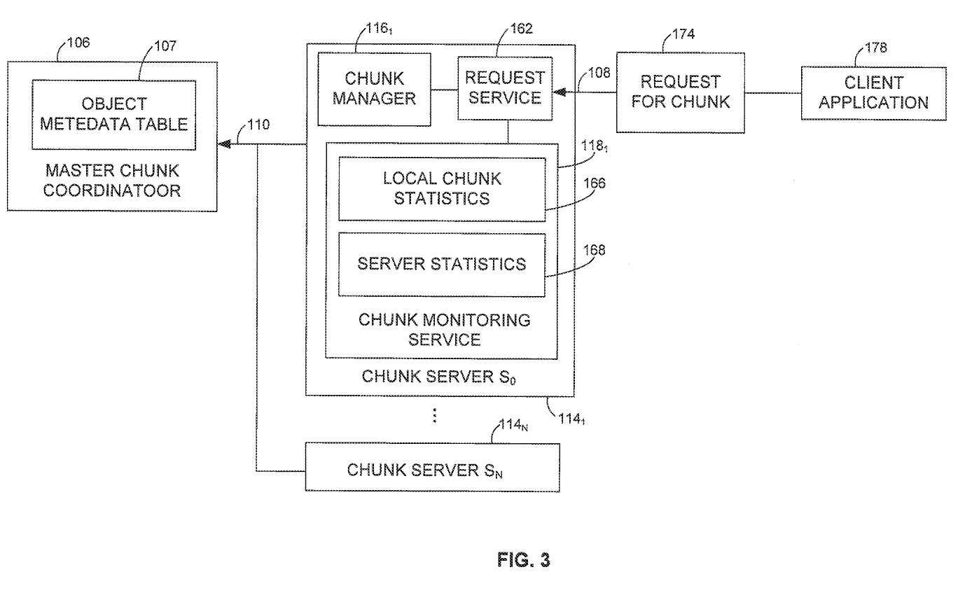

FIG. 3 is a block diagram illustrating one example of the system components for the monitoring and maintenance of chunk statistics. While FIG. 3 illustrates a request service 162, chunk manager 116₁, and chunk monitoring service 118₁ of chunk server 114₁, each chunk server 114₁-114_{N} includes a respective request service, chunk manager, and chunk monitoring service. A client application 178 submits a request for a chunk 174 (e.g., read, write, append, remove) to chunk server 114₁ through communication path 108. Request processing 162 of chunk server 114₁ receives the request and sends the request to chunk manager 116₁ to complete the request. In addition, request processing 162 sends the request to chunk monitoring service 118₁.

Chunk monitoring service 118₁ collects and maintains local chunk statistics 166 and server statistics 168. Local chunk statistics 166 may include hotness statistics, reuse statistics, read/write ratio statistics, concurrency statistics or other suitable statistics for each chunk stored on chunk server 114₁. Sever statistics 168 may include server load or other suitable statistics. Chunk server 114₁ periodically transmits the local chunk statistics and server statistics to master chunk coordinator 106 through communication path 110 to update object metadata table 107.

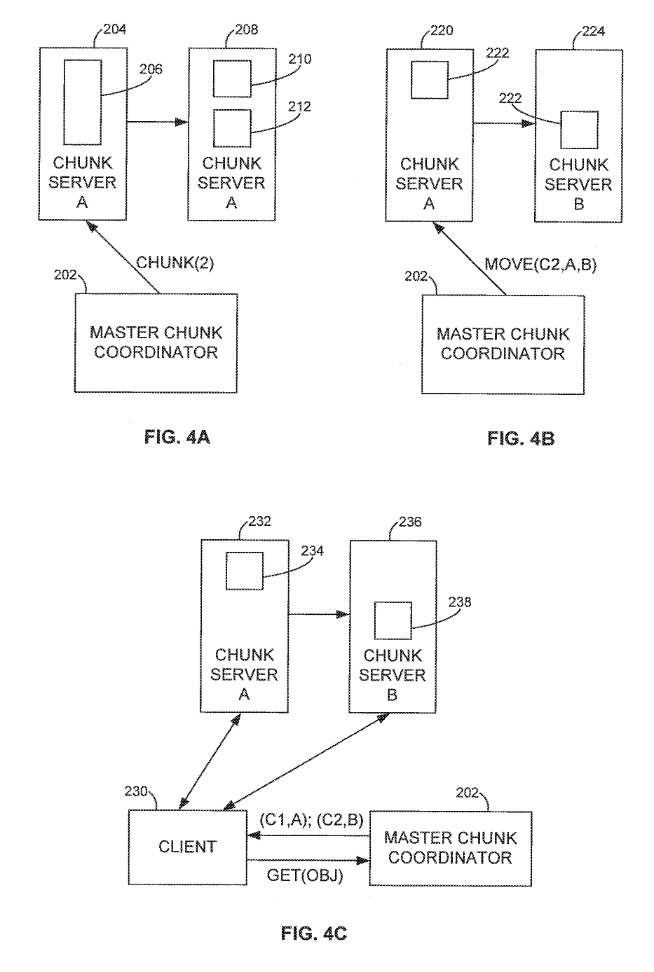

FIG. 4A-4C illustrate one example of chunking. FIG. 4A illustrates one example of re-chunking an object such as splitting one chunk of an object into two chunks. In this example, a master chunk coordinator 202 issues a command (i.e., CHUNK(2)) to chunk server A to split chunk 206 as indicated at 204. In response to the command, chunk server A splits chunk 206 into chunks 210 and 212 as indicated at 208.

FIG. 4B illustrates one example of chunk migration. In this example, master chunk coordinator 202 issues a command (i.e., MOVE(C2,A,B)) to chunk server A to move chunk 222 as indicated at 220 to chunk server B. In response to the command, chunk server A moves (i.e., transmits) chunk 222 to chunk server B as indicated at 224.

FIG. 4C illustrates one example of serving chunks to a client. A client sends a request for an object (i.e., GET (OBJ)) to master chunk coordinator 202. In response to the request, master chunk coordinator 202 informs client 230 of the location of the chunks for the object via a response (i.e., (C1,A);(C2,B)). In this example, the object includes a first chunk on chunk server A and a second chunk on chunk server B. In response to being informed about the location of each chunk of the object, client 230 sends an individual request to chunk server A for chunk 234 as indicated at 232 and sends another individual request to chunk server B for chunk 238 as indicated at 236.

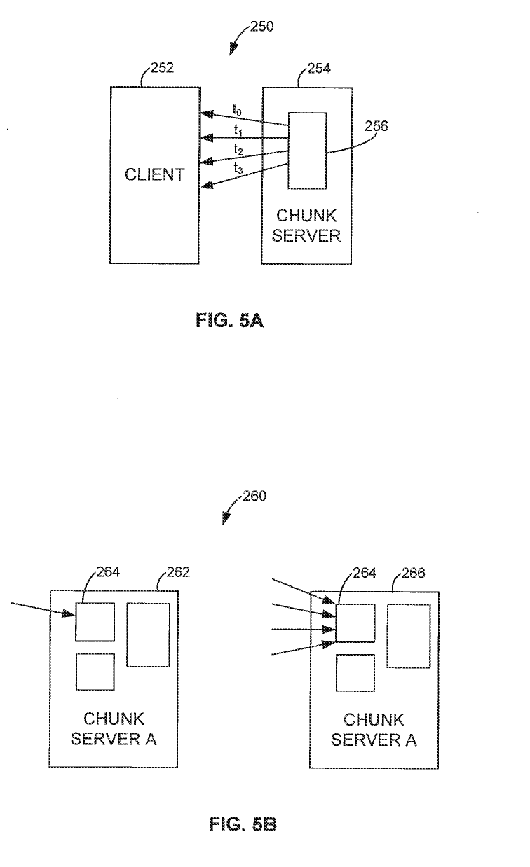

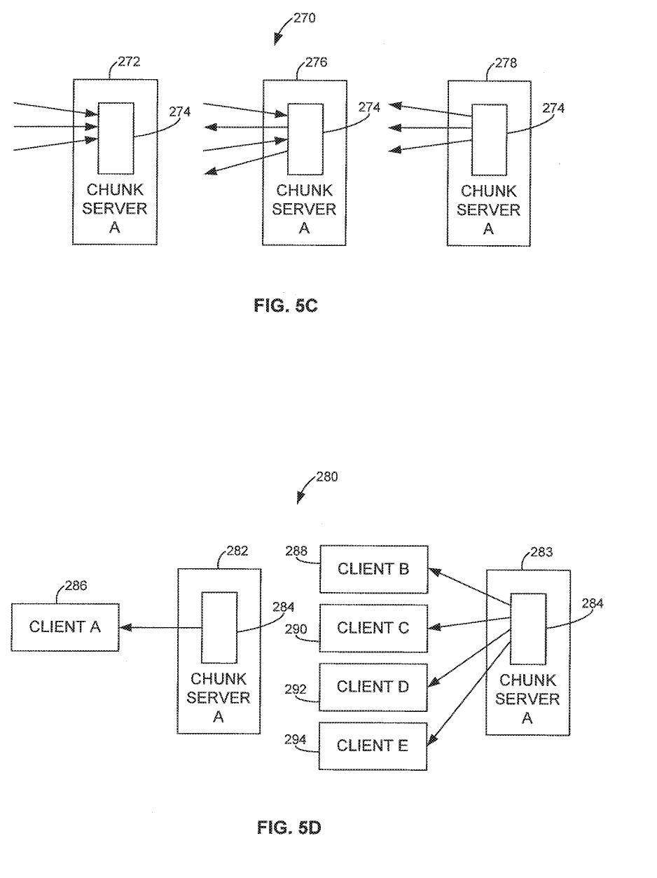

FIG. 5A illustrates one example of chunk reuse 250. As used herein, chunk “reuse” is defined as the number of accesses by an individual client (e.g., client 252) to a chunk (e.g., chunk 256) of a chunk server (e.g., chunk server 254) within a window of time (e.g., t₀, t₁, t₂, t₃). Chunk reuse may be used to suggest when and where replicas are created to reduce load on the network.

FIG. 5B illustrates one example of chunk hotness 260. As used herein, chunk “hotness” is defined as the relative load a chunk contributes to an individual chunk server in the system. Chunk hotness may be defined as the number of read or write requests to a specific chunk over a finite interval of time. As illustrated in FIG. 5B for example, at 262 the chunk hotness of chunk 264 is less than the chunk hotness of chunk 264 at 266 based on the number of accesses as indicated by the arrows.

FIG. 5C illustrates one example of chunk read/write ratio 270. As used herein, the chunk “read/write ratio” defines how a chunk is accessed by clients and guides the degree of consistency provided by the system. As illustrated in FIG. 5C for example, at 272, chunk 274 has only write requests as indicated by the arrows such that the read/write ratio is zero. At 276, chunk 274 has an equal number of read and write requests as indicated by the arrows such that the read/write ratio is 0.5. At 278, chunk 274 has only read requests as indicated by the arrows such that the read/write ratio is one.

FIG. 5D illustrates one example of chunk concurrent demand 280. As used herein, “concurrent demand” is defined as the number of unique clients accessing a chunk in a given window of time. A higher demand combined with a certain read/write ratio and consistency level will guide the system to appropriately apply replication and chunking to attain improved quality-of-service. For example, a read-mostly chunk with high reuse factor may be aggressively replicated to increase locality with respect to the request originator to avoid transmission of repeated copies of data over the network. As illustrated in FIG. 5D, one client (e.g., client A 286) accesses chunk 284 of chunk server A such that chunk 284 has a low concurrent demand as indicated at 282. As indicated at 283, chunk 284 has a higher concurrent demand as the chunk is accessed by multiple clients concurrently (e.g., client B 288, client C 290, client D 292, and client E 294).

“Relatedness” of objects as used herein, defines the spatial locality between objects. For each client in a window of time, the unique set of objects accessed defines the working set. On the master chunk coordinator, a vector is maintained for each object containing counters representing how often the object is discovered in the recent working set for that client. Each time objects are found in the working set, the value at an index representing other objects in the set is incremented. Observations about such characteristics may be leveraged to provide predictions about which objects mays be accessed in the future. Prefetching or aggressive copying techniques may prepare related objects for serving to the client.

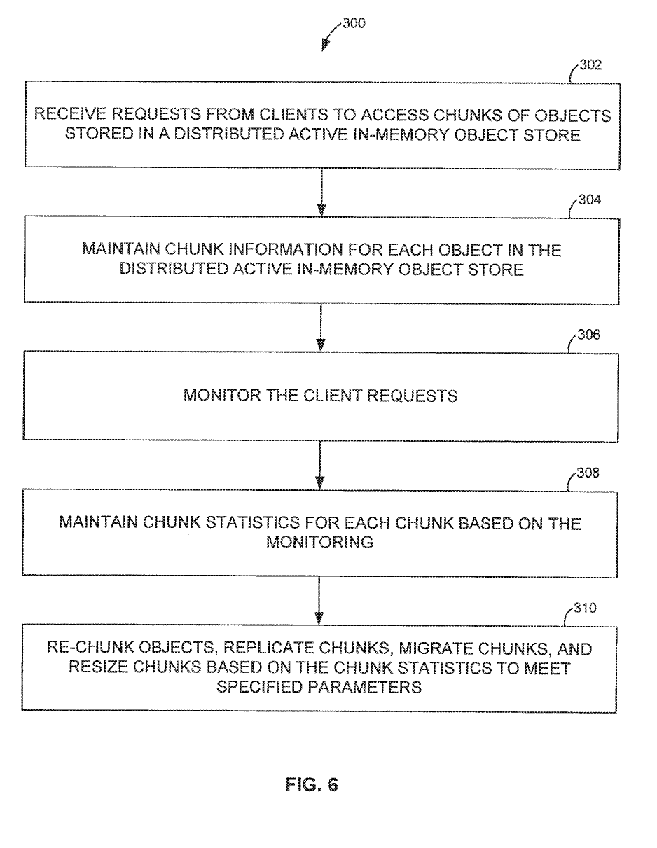

FIG. 6 is a flow diagram illustrating one example of a method 300 for operating a system, such as system 100 previously described and illustrated with reference to FIG. 1. At 302, requests are received from clients to access chunks of objects stored in a distributed active in-memory object store. At 304, chunk information is maintained for each object in the distributed active in-memory object store. At 306, the client requests are monitored. At 308, chunk statistics for each chunk are maintained based on the monitoring. In one example, maintaining chunk statistics includes maintaining hotness, reuse, read/write ratio, concurrent demand, and relatedness statistics for each chunk. At 310, the method includes re-chunking objects, replicating chunks, migrating chunks, and resizing chunks based on the chunk statistics to meet specified parameters.

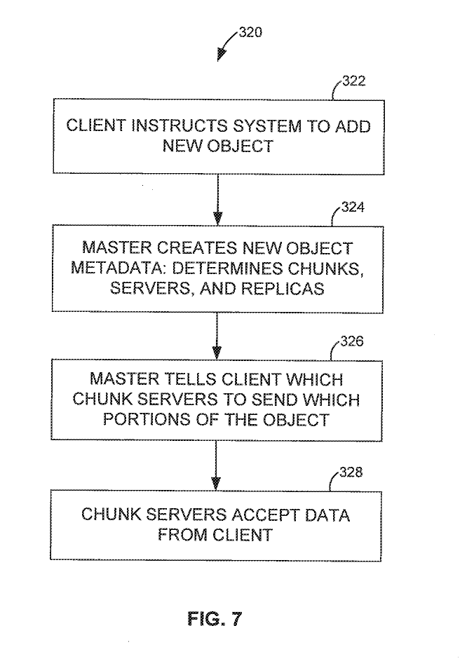

FIG. 7 is a flow diagram illustrating one example of a method 320 for adding an object to the system, such as system 100 previously described and illustrated with reference to FIG. 1. At 322, a client instructs the system to add a new object. At 324, the master chunk coordinator creates new object metadata by determining chunks for the objects including the number of chunks and the length of each chunk, the number of replicas of each chunk, and the chunk servers on which to store the replicas. At 326, the master chunk coordinator tells the client which chunk servers to send which portions of the object for storage as chunk replicas on the chunk servers. At 328, the chunk servers accept the data from the client for storage on the chunk servers.

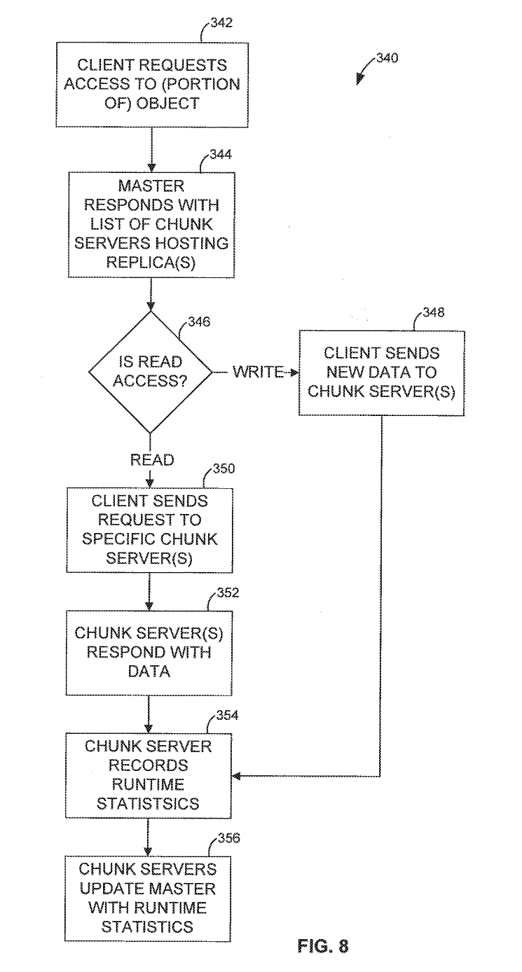

FIG. 8 is a flow diagram illustrating one example of a method 340 for client access of an object in the system, such as system 100 previously described and illustrated with reference to FIG. 1. At 342, a client requests access to an object or portion of an object. At 344, the master chunk coordinator responds with a list of chunk servers hosting a replica or replicas for the requested object or portion. At 346, if the request is a write access request, then at 348 the client sends new data for the object to the chunk server or chunk servers listed by the master chunk coordinator and flow continues to block 354. At 346, if the request is a read access request, then at 350 the client sends the request to the specific chunk server or chunk servers listed by the master chunk coordinator. At 352, the chunk server or chunk servers respond and provide the requested data to the client. At 354, the chunk server or chunk servers record runtime statistics (e.g., hotness, reuse, read/write ratio, and concurrent demand) for the accessed chunks. At 356, the chunk server or chunk servers update the master chunk coordinator with the runtime statistics.

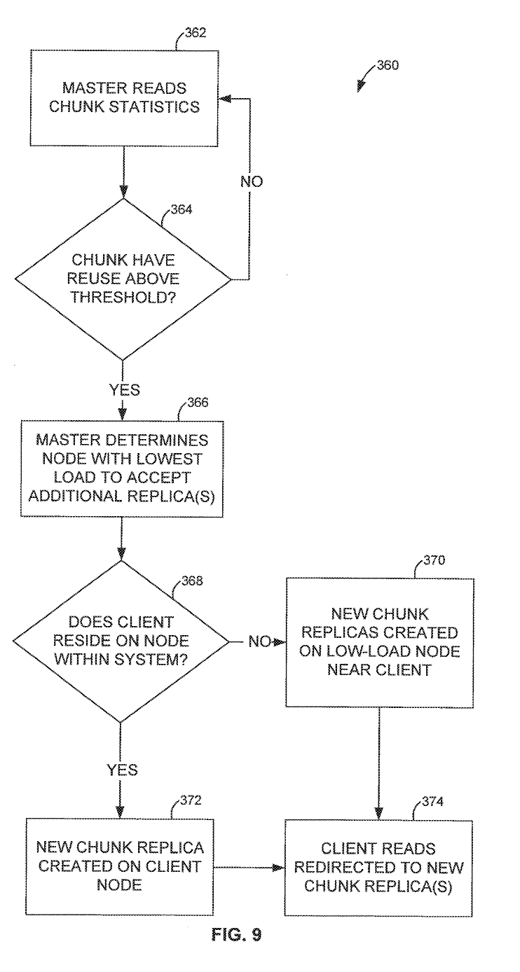

FIG. 9 is a flow diagram illustrating one example of a method 360 for replicating a chunk based on reuse. At 362, the master chunk coordinator reads the chunk statistics. At 364, if a chunk does not have reuse above a threshold value, then the master chunk coordinator continues to read the chunk statistics at 362. At 364, if a chunk does have reuse above the threshold value, then at 366 the master chunk coordinator determines the node (e.g., chunk server) with the lowest loads to accept an additional replica or replicas for the chunk. At 368, if the client does not reside on a node within the system, then at 370 a new chunk replica is created on a low-load node identified by the master chunk coordinator near (e.g., physically closer to) the client. At 368, if the client does reside on a node within the system, then at 372 a new chunk replica is created on the client node. In either case, at 374 the client read requests are redirected to the new chunk replica or replicas.

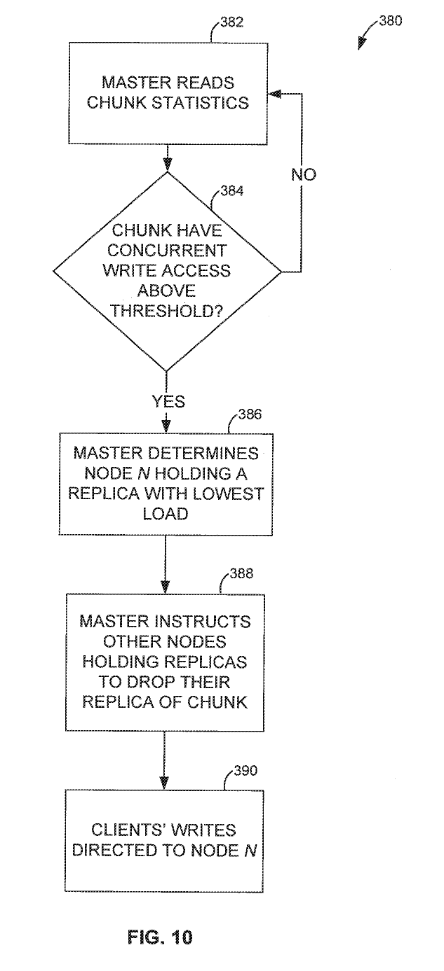

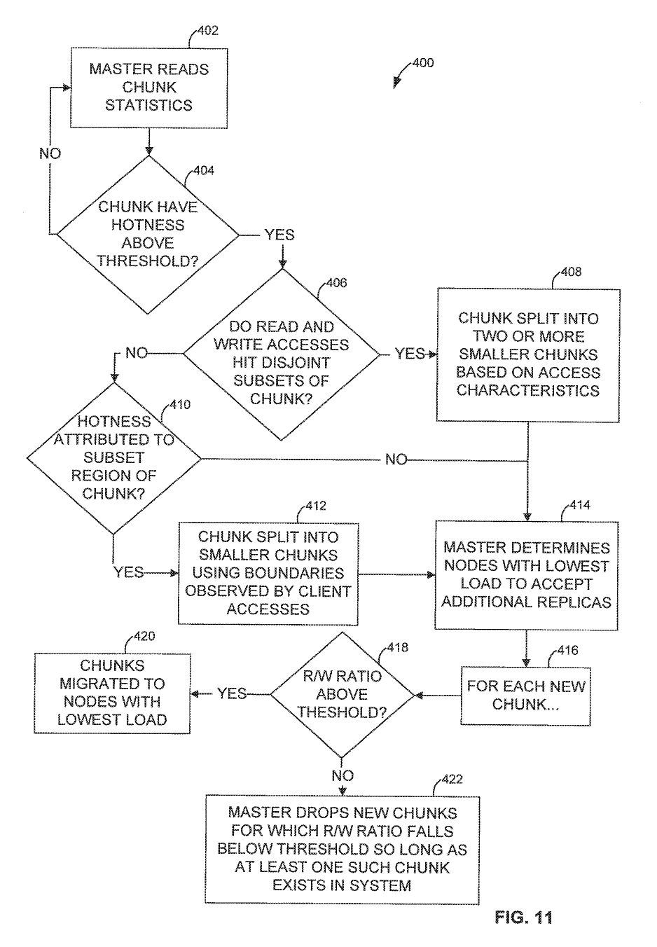

FIG. 10 is a flow diagram illustrating one example of a method 380 for accessing chunks based on concurrent demand. At 382, the master chunk coordinator reads the chunk statistics. At 384, if a chunk does not have concurrent write accesses above a threshold value, then the master chunk coordinator continues to read the chunk statistics at 382. At 384, if a chunk does have concurrent write accesses above a threshold value, then at 386 the master chunk coordinator determines a node N (e.g., chunk server) holding a replica with the lowest load. At 388, the master chunk coordinator instructs other nodes holding replicas to drop (i.e., delete) their replica of the chunk. At 390, the client write requests are redirected to node N.

FIG. 11 is a flow diagram illustrating one example of a method 400 for splitting chunks (i.e., re-chunking) based on the chunk hotness and chunk read/write ratio. At 402, the master chunk coordinator reads the chunk statistics. At 404, if a chunk does not have hotness above a threshold value, then the master chunk coordinator continues to read the chunk statistics at 402. At 404, if a chunk has hotness above the threshold value, then flow continues to decision block 406. At 406, if read and write accesses hit disjoint subsets of the chunk, then at 408 the chunk is split into two or more smaller chunks based on access characteristics to the chunk and flow continues to block 414. At 406, if read and write accesses do not hit disjoint subsets of the chunk, flow continues to decision block 410. At 410, if the hotness is attributed to a subset region of the chunk, then at 412 the chunk is split into smaller chunks using boundaries observed by client accesses and flow continues to block 414. At 410, if the hotness is not attributed to a subset region of the chunk, then flow continues to block 414.

At 414, the master chunk coordinator determines nodes with the lowest load to accept additional replicas. At 416, for each new chunk flow continues to decision block 418. At 418, if the read/write ratio for the new chunk is above a threshold value, then at 420 chunks are migrated to nodes with the lowest load as identified by the master chunk coordinator. At 418, if the read/write ratio is not above the threshold value, then at 422 the master chunk coordinator drops (i.e., deletes) new chunks for which the read/write ratio falls below another threshold value so long as at least one such chunk exists in the system.

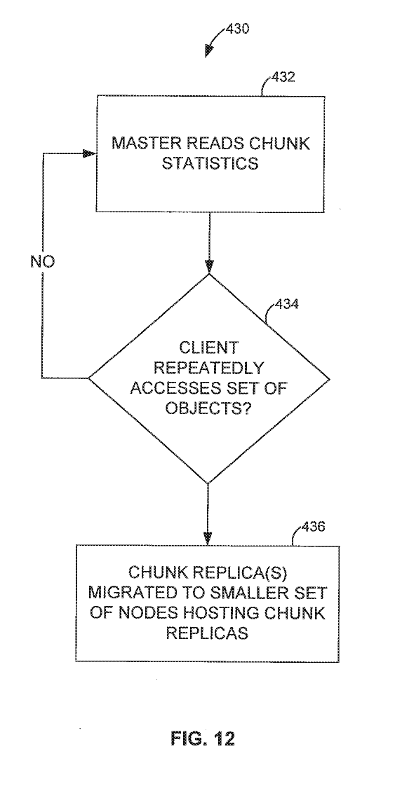

FIG. 12 is a flow diagram illustrating one example of a method 430 for migrating chunks based on relatedness. At 432, the master chunk coordinator reads the chunk statistics. At 434, if a client is not repeatedly accessing a set of objects, then the master chunk coordinator continues to read the chunk statistics at 432. At 434, if a client is repeatedly accessing a set of objects, then at 436 a chunk replica or replicas are migrated to a smaller set of nodes hosting chunk replicas.

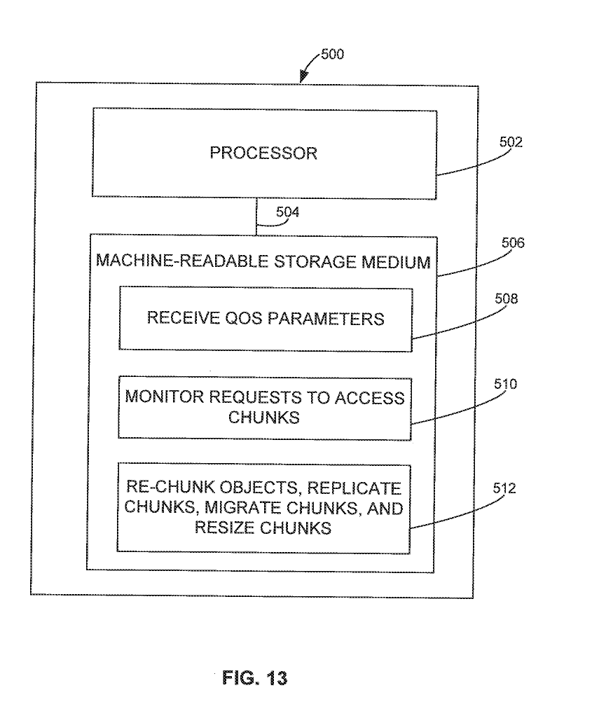

FIG. 13 is a block diagram illustrating one example of a processing system 500. System 500 may include at least one computing device and may provide master chunk coordinator 106 previously described and illustrated with reference to FIGS. 1-3. System 500 includes a processor 502 and a machine-readable storage medium 506. Processor 502 is communicatively coupled to machine-readable storage medium 506 through a communication path 504. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 includes one or more Central Processing Units (CPUs), microprocessors, and/or other suitable hardware devices for retrieval and execution of instructions stored in machine-readable storage medium 506. Processor 502 may fetch, decode, and execute instructions 508 to receive quality-of-service parameters, instructions 510 to monitor client requests to access chunks, and instructions 512 to instruct chunk servers to re-chunk objects, replicate chunks, migrate chunks, and resize chunks based on the monitoring. As an alternative or in addition to retrieving and executing instructions, processor 502 may include one or more electronic circuits comprising a number of electronic components for performing the functionality of one or more of the instructions in machine-readable storage medium 506. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 506 is a non-transitory storage medium and may be any suitable electronic, magnetic, optical, or other physical storage device that stores executable instructions. Thus, machine-readable storage medium 506 may be, for example, Random Access Memory (RAM), an Electrically-Erasable Programmable Read-Only Memory (EEPROM), a storage drive, an optical disc, and the like. Machine-readable storage medium 506 may be disposed within system 500, as illustrated in FIG. 13. In this case, the executable instructions may be installed on system 500. Alternatively, machine-readable storage medium 506 may be a portable, external, or remote storage medium that allows system 500 to download the instructions from the portable/external/remote storage medium. In this case, the executable instructions may be part of an installation package.

Machine-readable storage medium 506 stores instructions to be executed by a processor (e.g., processor 502) including instructions 508, 510, and 512 to operate system 100 as previously described and illustrated with reference to FIGS. 1-12. Processor 502 may execute instructions 508 to receive from a client application quality-of-service parameters for storing objects in a distributed active in-memory object store comprising a plurality of chunk servers. Processor 502 may execute instructions 510 to monitor requests from the client application to access chunks of objects. Processor 502 may execute instructions 512 to instruct the chunk servers to re-chunk objects, replicate chunks, migrate chunks, and resize chunks to distribute chunks of objects across the plurality of chunk servers based on the monitoring to maintain compliance with the quality-of-service parameters.

In one example, processor 502 may also execute instructions to receive chunk statistics for each chunk in response to the monitoring. The chunk statistics may include hotness, reuse, read/write ratio, concurrent demand, and relatedness. Processor 502 may execute instructions to re-chunk objects, replicate chunks, migrate chunks, and resize chunks based on the chunk statistics to maintain compliance with the quality-of-service parameters.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a plurality of clients, each client to submit requests to access chunks of objects;
a master chunk coordinator to maintain chunk information for each object; and
a plurality of chunk servers to store chunks, each chunk server including a chunk monitor to monitor client requests, maintain chunk statistics for each chunk based on the monitoring, and transmit the chunk statistics for each chunk to the master chunk coordinator,
wherein the master chunk coordinator instructs the chunk servers to re-chunk objects, replicate chunks, migrate chunks, and resize chunks based on the chunk statistics to meet specified parameters.

2. The system of claim 1, wherein the chunk statistics comprise hotness, reuse, read/write ratio, concurrent demand, and relatedness.

3. The system of claim 1, wherein the chunk information for each object comprises static object information and dynamic object information, the dynamic object information comprising a chunk list indicating each chunk of the object, ordering of the chunks, each chunk replica, and each chunk location.

4. The system of claim 3, wherein the chunk list comprises static chunk information and dynamic chunk information for each chunk, the dynamic chunk information comprising reuse, read/write ratio, and concurrent demand statistics for the chunk.

5. The system of claim 1, wherein the master chunk coordinator and the plurality of chunk servers provide a distributed active in-memory object store.

6. A machine-readable storage medium encoded with instructions, the instructions executable by a processor of a system to cause the system to:
receive from a client application quality-of-service parameters for storing objects in a distributed active in-memory object store comprising a plurality of chunk servers;
monitor requests from the client application to access chunks of objects; and
instruct the chunk servers to re-chunk objects, replicate chunks, migrate chunks, and resize chunks to distribute chunks of objects across the plurality of chunk servers based on the monitoring to maintain compliance with the quality-of-service parameters.

7. The machine-readable storage medium of claim 6, wherein the instructions are executable by the processor to further cause the system to:
receive chunk statistics for each chunk in response to the monitoring, the chunk statistics comprising hotness, reuse, read/write ratio, concurrent demand, and relatedness; and
re-chunk objects, replicate chunks, migrate chunks, and resize chunks based on the chunk statistics to maintain compliance with the quality-of-service parameters.

8. The machine-readable storage medium of claim 7, wherein the instructions are executable by the processor to further cause the system to:
replicate a chunk in response to hotness of the chunk exceeding a threshold value.

9. The machine-readable storage medium of claim 7, wherein the instructions are executable by the processor to further cause the system to:
identify a chunk server having the lowest load and directing write accesses for a chunk to a chunk replica on the identified chunk server in response to concurrent write accesses to the chunk exceeding a threshold value.

10. The machine-readable storage medium of claim 7. wherein the instructions are executable by the processor to further cause the system to:
migrate chunk replicas for a set of objects from a larger set of chunk servers to a smaller set of chunk servers in response to a client repeatedly accessing the set of objects.

11. A method comprising:
receiving requests from clients to access chunks of objects stored in a distributed active in-memory object store;
maintaining chunk information for each object n the distributed active in-memory object store;
monitoring the client requests;
maintaining chunk statistics for each chunk based on the monitoring; and
re-chunking objects, replicating chunks, migrating chunks, and resizing chunks based on the chunk statistics to meet specified parameters.

12. The method of claim 11, wherein maintaining chunk statistics comprises maintaining hotness, reuse, read/write ratio, concurrent demand, and relatedness statistics for each chunk.

13. The method of claim 12, further comprising:
splitting a larger chunk into a plurality of smaller chunks based on access characteristics in response to the larger chunk having a hotness above a threshold value and read and write accesses to the larger chunk hitting disjoint subsets of the larger chunk.

14. The method of claim 12, further comprising:
splitting a larger chunk into a plurality of smaller chunks using boundaries observed by client accesses in response to the larger chunk having a hotness above a threshold value where the hotness is attributed to a subset region of the larger chunk.

15. The method of claim 12, further comprising:
migrating a chunk from a chunk server having a higher load to a chunk server having a lower load in response to a read/write ratio of that chunk exceeding a first threshold value; and
deleting replica chunks while maintaining at least one such chunk replica in response to a read/write ratio of a chunk falling below a second threshold value.
